(19) United States
(12) Patent Application Publication
(10) Pub. No.: US 2012/0196577 A1
(43) Pub. Date: Aug. 2, 2012

(54) SYSTEMS AND METHODS FOR MONITORING BOOK-RELATED ACTIVITIES

(75) Inventor: YAT WAI EDWIN KWONG, Hong Kong (HK)

(73) Assignee: LEARNING MONITORING LIMITED, Hong Kong (HK)

(21) Appl. No.: 13/015,781

(22) Filed: Jan. 28, 2011

(51) Int. Cl. H04M 3/42; H04M 1/00

(52) U.S. Cl. 455/414.1; 455/556.1

(57) ABSTRACT

Systems and methods are provided for monitoring book-related activities. One embodiment includes a book activity monitoring system that generates alerts to users for alarming activities relating to various uses of electronic books. In addition, the exemplary system comprises using a camera at the front side and the back side to capture images of the reader. Further, after the creation of the snapshot, monitoring alert may be generated to notify the user, allowing the user to create annotated versions of the electronic book.

### BACKGROUND

I. Technical Field

The present invention generally relates to systems and methods for monitoring book-related activities. Specifically, and without limitation, the invention relates to generating alerts to users for alarming activities relating to various uses of electronic books.

II. Background Information

E-book is becoming very popular. An e-book is an electronic version of a traditional print book that can be read by using a personal computer or by using an e-book reader. An e-book reader, meanwhile, can be a software application for use on a computer, such as Adobe Reader application, or a book-sized computer that is used solely as a reading device, such as Apple's iphone or Google's smartphone. With these devices, users may directly purchase reading material from relevant online stores. In some cases, free e-books are readily available for download as downloadable files. Generally, an e-book can be downloaded in five minutes or less. In such a short period of time, accessing readable content becomes more readily available.

With the emergence of the above-stated portable devices, e-books can be viewed not only on PC but phones. Currently, there are limited means to avoid e-books being read by unauthorized readers, such as young adults. This invention is for parents to set control measures for monitoring the children reading e-books that contain sensitive or restricted information,

The modern e-book readers may be read from the portable devices, which come with a wide variety of peripheral components, such as cameras and electronic locators. However, current integration between the readers and these other peripheral components are still sorely lacking. These applications, when properly integrated, would allow users to tightly control how e-books should be read properly, particularly in connection with controls applicable to young children.

In view of the foregoing, there is a need for systems and methods that can monitor book-related activities. There is also a need for systems and methods that can set up rules regarding how electronic books can be read. In case of alarming activities, there is also a need to generate alerts that direct the activities to certain users' attention with respect to the restricted uses of electronic books.

### SUMMARY

Embodiments of the present invention relates to methods and systems for monitoring system. Consistent with embodiments of the invention, a phone may be provided. The phone, according to the embodiments, may include an attribute to represent a user; an associated email address of the user; a front camera device placed on front of the phone that captures readers; and a back camera device placed on back of the phone that captures reading environment.

Additionally, the phone in the embodiments may include an electronic book displayable on the phone, wherein the book includes a book name; and at least one session of the book is marked with a restricted rating proposed for the book's intended reader; allowed to be read at a allowed time period; marked as confidential sessions; allowed to be read at a allowed time period; and allowed to be read at a permitted location.

Further, a clock may be included in the phone, which is used to detect whether the session of the book is being read outside the allowed time period. The phone further includes a location detection unit used to detect whether the session of the book is being read at the permitted location; and a processing unit adapted to execute a set of instructions stored in a memory.

The processing unit, in one embodiment, may comprise opening the book, after a request is made by a reader to display the book on the phone; opening the session of the book, after a request is made by the reader to display the session of the book that is marked with the restricted rating proposed for the book's intended reader, wherein during the opening of the session, a snapshot is taken.

Further, in taking the snapshot, the camera may be used at the front to capture an image of the reader; using the camera at the back to capture an image of the reading environment; performing a print-screen function to capture what is being displayed on the phone; using the clock to record current time of the opening of the session; associating the session of the book with the snapshot; creating an index for the snapshot; and storing the index for the snapshot.

After the creation of the snapshot, a monitoring alert may be created to notify the user, wherein the alert includes the snapshot. According to the embodiment, the user may be allowed to browse the snapshot through the index. Upon request of the user, an annotated version of the electronic book may be created. Also, at this time, a bookmark for the annotated version of the electronic book may be created. Additional embodiments may also support adding the snapshot into the bookmark; including the snapshot into the annotated version of the electronic book as annotations; and including the index for the snapshots into the annotated version of the electronic book that facilities searching of reading history of the electronic book.

According to another embodiment, the user may a parent user or any superior users over the readers of the electronic book. In addition, the set of instructions comprises, after the snapshot is taken, browsing at the session of the book that includes words inappropriate for young adults. During the browsing of the session, a second snapshot may be taken. At this time, the second snapshot be allowed to use the camera at the front to capture an second image of the reader. Further, the inventive methods and systems may be configured so that other features are supported operationally. These features include using the camera at the back to capture an second image of the reading environment; performing a print-screen function to capture what is being displayed on the phone; using the clock to record current time of the session; associating the session of the book with the snapshot; creating an index for the snapshot; and storing the index for the snapshot; and creating a second monitoring alert to notify the parent user after the creation of the second snapshot, wherein the alert includes the second snapshot.

Moreover, embodiments may further allow taking a third snapshot, which include browsing at the session of the book that is marked confidential, wherein during the browsing of the session, a third snapshot is taken. The snapshot comprises using the camera at the front to capture an third image of the reader; using the camera at the back to capture an third image of the reading environment; performing a print-screen function to capture what is being displayed on the phone; using the clock to record current time of the session; associating the session of the book with the snapshot; creating an index for the snapshot; and storing the index for the snapshot.

Even further, an embodiment may be configured to take a fourth snapshot, which include browsing at the session of the book that is being read outside the allowed time period, a fourth snapshot is taken. The snapshot comprises using the camera at the front to capture a fourth image of the reader; using the camera at the back to capture a fourth image of the reading environment; performing a print-screen function to capture what is being displayed on the phone; using the clock to record current time of the session; associating the session of the book with the snapshot; creating an index for the snapshot; and storing the index for the snapshot.

Moreover, a further embodiment provides that, wherein the set of instructions further comprises, after the fourth snapshot is taken, the fourth image includes an eye of the reader that can be used to analyze the concentration of the reader when reading the session. Embodiments of the present invention are not limited to systems. A computer-implemented method, according to one embodiment, comprises opening a book, after a request is made by a reader to display the book on a phone; opening a session of the book, after a request is made by the reader to display the session of the book that is marked with a restricted rating proposed for the book's intended reader, wherein during the opening of the session, a snapshot is taken, the snapshot comprising using a camera at the front to capture an image of the reader; using the camera at the back to capture an image of the reading environment; performing a print-screen function to capture what is being displayed on the phone; using a clock to record current time of the opening of the session; associating the session of the book with the snapshot; creating an index for the snapshot; and storing the index for the snapshot; after the creation of the snapshot, creating a monitoring alert to notify the user, wherein the alert includes the snapshot; allowing the user to browse the snapshot through the index; upon request of the user, creating an annotated version of the electronic book; creating a bookmark for the annotated version of the electronic book; adding the snapshot into the bookmark; including the snapshot into the annotated version of the electronic book as annotations; and including the index for the snapshots into the annotated version of the electronic book that facilities searching of reading history of the electronic book.

An alternative embodiment of an exemplary method includes browsing at a session of the book that includes words inappropriate for young adults, wherein during the browsing of the session, a second snapshot is taken, the snapshot comprising using the camera at the front to capture an second image of the reader; using the camera at the back to capture an second image of the reading environment; performing a print-screen function to capture what is being displayed on the phone; using the clock to record current time of the session; associating the session of the book with the snapshot; creating an index for the snapshot; and storing the index for the snapshot.

It is to be understood that both the foregoing general description and the following detailed description are exemplary and explanatory only, and are not restrictive of the scope of the invention, described and as claimed. Furthermore, features and variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram illustrating system monitoring book-related activities, consistent with an embodiment of the invention.

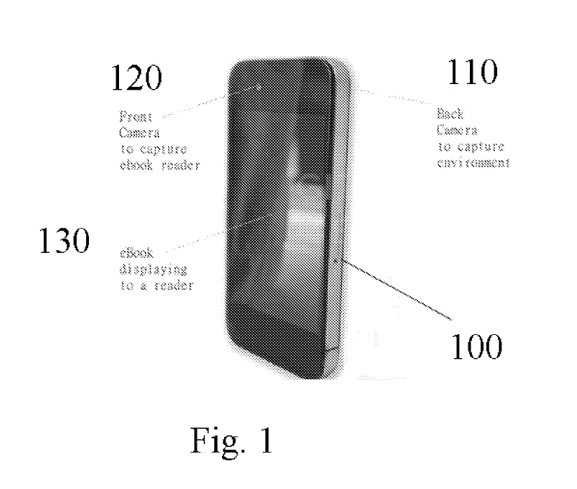

### DETAILED DESCRIPTION

Embodiments of the present invention relates to a book activity monitoring system. An exemplary system comprises a phone 100, which includes an attribute to represent a user; an associated email address of the user; a front camera 120 device placed on front of the phone 100 that captures readers; a back camera 110 device placed on back of the phone 100 that captures reading environment; an electronic book 130 displayable on the phone 100, wherein the book includes a book name; and at least one session of the book marked with a restricted rating proposed for the book's intended reader; allowed to be read at a allowed time period; marked as confidential sessions; allowed to be read at a allowed time period; and allowed to be read at a permitted location.

The phone 100 included in the exemplary system includes a clock used to detect whether the session of the book is being read outside the allowed time period; a location detection unit used to detect whether the session of the book is being read at the permitted location; a processing unit adapted to execute a set of instructions stored in a memory.

The processing unit, described in the exemplary system, includes opening the book, after a request is made by a reader to display the book on the phone 100; opening the session of the book, after a request is made by the reader to display the session of the book that is marked with the restricted rating proposed for the book's intended reader, wherein during the opening of the session, a snapshot is taken. When the snapshot is taken, the camera is used at the front to capture an image of the reader. During the snapshot being taken, the camera is further used at the back to capture an image of the reading environment. At this time, other features related to the exemplary phone 100 are disclosed, including performing a print-screen function to capture what is being displayed on the phone 100; using the clock to record current time of the opening of the session; associating the session of the book with the snapshot; creating an index for the snapshot; and storing the index for the snapshot.

After the creation of the snapshot, a monitoring alert may be created to notify the user, wherein the alert includes the snapshot. The phone 100 may be further setup so that additional features such are the following are supported: allowing the user to browse the snapshot through the index; upon request of the user, creating an annotated version of the electronic book 130; creating a bookmark for the annotated version of the electronic book 130; adding the snapshot into the bookmark; including the snapshot into the annotated version of the electronic book 130 as annotations; and including the index for the snapshots into the annotated version of the electronic book 130 that facilities searching of reading history of the electronic book 130.

An alternate book activity monitoring system is alternatively disclosed. The system comprises a phone 100 including: an attribute to represent a parent user; an associated email address of the parent user; a front camera 120 device placed on front of the phone 100 that captures readers; a back camera 110 device placed on back of the phone 100 that captures reading environment; an electronic book 130 displayable on the phone 100, wherein the book includes a book name; and at least one session of the book is marked with a restricted rating proposed for the book's intended reader; is allowed to be read at a allowed time period; is marked as confidential sessions; is allowed to be read at a allowed time period; and is allowed to be read at a permitted location.

In this exemplary example, a clock is used to detect whether the session of the book is being read outside the allowed time period. Further, a location detection unit may be deployed to detect whether the session of the book is being read at the permitted location. More, a processing unit is also disclosed, which is adapted to execute a set of instructions stored in a memory.

The set of instructions include opening the book, after a request is made by a young reader to display the book on the phone 100; opening the session of the book, after a request is made by the reader to display the session of the book that is marked with the restricted rating proposed for the book's intended reader, wherein during the opening of the session, a snapshot is taken, the snapshot comprising: using the camera at the front to capture an image of the reader; using the camera at the back to capture an image of the reading environment; performing a print-screen function to capture what is being displayed on the phone 100; using the clock to record current time of the opening of the session; associating the session of the book with the snapshot; creating an index for the snapshot; and storing the index for the snapshot; browsing at the session of the book that includes words inappropriate for young adults, wherein during the browsing of the session, a second snapshot is taken, the snapshot comprising: using the camera at the front to capture an second image of the reader; using the camera at the back to capture an second image of the reading environment; performing a print-screen function to capture what is being displayed on the phone 100; using the clock to record current time of the session; associating the session of the book with the snapshot; creating an index for the snapshot; and storing the index for the snapshot.

After the creation of the snapshot, creating a monitoring alert to notify the parent user, wherein the alert includes the snapshot; the set of instructions include: after the creation of the second snapshot, creating a second monitoring alert to notify the parent user, wherein the alert includes the second snapshot; allowing the parent user to browse the snapshot through the index; upon request of the parent user, creating an annotated version of the electronic book 130; creating a bookmark for the annotated version of the electronic book 130; adding the snapshots into the bookmark; including the snapshots into the annotated version of the electronic book 130 as annotations; and including the index for the snapshots into the annotated version of the electronic book 130 that facilities searching of reading history of the electronic book 130.

In another implementation, the invention relates to a book activity monitoring system that comprises a phone 100 including: an attribute to represent a parent user; an associated email address of the parent user; a front camera 120 device placed on front of the phone 100 that captures readers; a back camera 110 device placed on back of the phone 100 that captures reading environment; an electronic book 130 displayable on the phone 100, wherein the book includes a book name; and at least one session of the book is marked with a restricted rating proposed for the book's intended reader; is allowed to be read at a allowed time period; is marked as confidential sessions; is allowed to be read at a allowed time period; and is allowed to be read at a permitted location; a clock used to detect whether the session of the book is being read outside the allowed time period; a location detection unit used to detect whether the session of the book is being read at the permitted location; and a processing unit adapted to execute a set of instructions stored in a memory.

In this example, the set of instructions further include opening the book, after a request is made by a young reader to display the book on the phone 100; opening the session of the book, after a request is made by the reader to display the session of the book that is marked with the restricted rating proposed for the book's intended reader, wherein during the opening of the session, a snapshot is taken, the snapshot comprising using the camera at the front to capture an image of the reader; using the camera at the back to capture an image of the reading environment; performing a print-screen function to capture what is being displayed on the phone 100; using the clock to record current time of the opening of the session; associating the session of the book with the snapshot; creating an index for the snapshot; and storing the index for the snapshot; browsing at the session of the book that includes words inappropriate for young adults, wherein during the browsing of the session, a second snapshot is taken, the snapshot comprising using the camera at the front to capture an second image of the reader; using the camera at the back to capture an second image of the reading environment; performing a print-screen function to capture what is being displayed on the phone 100; using the clock to record current time of the session; associating the session of the book with the snapshot; creating an index for the snapshot; and storing the index for the snapshot.

In the example, the set of instructions further includes browsing at the session of the book that is marked confidential, wherein during the browsing of the session, a third snapshot is taken, the snapshot comprising using the camera at the front to capture an third image of the reader; using the camera at the back to capture an third image of the reading environment; performing a print-screen function to capture what is being displayed on the phone 100; using the clock to record current time of the session; associating the session of the book with the snapshot; creating an index for the snapshot; and storing the index for the snapshot; after the creation of the snapshots, creating a monitoring alert to notify the parent user, wherein the alert includes the snapshots; allowing the parent user to browse the snapshots through the index; upon request of the parent user, creating an annotated version of the electronic book 130; creating a bookmark for the annotated version of the electronic book 130; adding the snapshots into the bookmark; including the snapshots into the annotated version of the electronic book 130 as annotations; and including the index for the snapshots into the annotated version of the electronic book 130 that facilities searching of reading history of the electronic book 130.

Another implementation illustrates a different level of user control. In the implementation, a book activity monitoring system is provided, which comprises a phone 100 including: an attribute to represent a parent user; an associated email address of the parent user; a front camera 120 device placed on front of the phone 100 that captures readers; a back camera 110 device placed on back of the phone 100 that captures reading environment; an electronic book 130 displayable on the phone 100, wherein the book includes a book name; and at least one session of the book is marked with a restricted rating proposed for the book's intended reader; is allowed to be read at a allowed time period; is marked as confidential sessions; is allowed to be read at a allowed time period; and is allowed to be read at a permitted location; clock used to detect whether the session of the book is being read outside the allowed time period; a location detection unit used to detect whether the session of the book is being read at the permitted location; a processing unit adapted to execute a set of instructions stored in a memory, comprising: opening the book, after a request is made by a young reader to display the book on the phone 100; opening the session of the book, after a request is made by the reader to display the session of the book that is marked with the restricted rating proposed for the book's intended reader, wherein during the opening of the session, a snapshot is taken.

During the snapshot, the example supports using the camera at the front to capture an image of the reader; using the camera at the back to capture an image of the reading environment; performing a print-screen function to capture what is being displayed on the phone 100; using the clock to record current time of the opening of the session; associating the session of the book with the snapshot; creating an index for the snapshot; and storing the index for the snapshot; browsing at the session of the book that includes words inappropriate for young adults, wherein during the browsing of the session, a second snapshot is taken, the snapshot comprising using the camera at the front to capture an second image of the reader; using the camera at the back to capture an second image of the reading environment; performing a print-screen function to capture what is being displayed on the phone 100; using the clock to record current time of the session; associating the session of the book with the snapshot; creating an index for the snapshot; and storing the index for the snapshot.

Additionally, browsing at the session of the book that is marked confidential is disclosed. In this case, during the browsing of the session, a third snapshot is taken, the snapshot comprising using the camera at the front to capture an third image of the reader; using the camera at the back to capture an third image of the reading environment; performing a print-screen function to capture what is being displayed on the phone 100; using the clock to record current time of the session; associating the session of the book with the snapshot; creating an index for the snapshot; and storing the index for the snapshot; browsing at the session of the book that is being read outside the allowed time period, a fourth snapshot is taken, the snapshot comprising using the camera at the front to capture an fourth image of the reader; using the camera at the back to capture an fourth image of the reading environment; performing a print-screen function to capture what is being displayed on the phone 100; using the clock to record current time of the session; associating the session of the book with the snapshot; creating an index for the snapshot; and storing the index for the snapshot; after the creation of the snapshots, creating a monitoring alert to notify the parent user, wherein the alert includes the snapshots; allowing the parent user to browse the snapshots through the index; upon request of the parent user, creating an annotated version of the electronic book 130; creating a bookmark for the annotated version of the electronic book 130; adding the snapshots into the bookmark; including the snapshots into the annotated version of the electronic book 130 as annotations; and including the index for the snapshots into the annotated version of the electronic book 130 that facilities searching of reading history of the electronic book 130.

Other means to control reading are supported. They can be shown in the next example. In this example, an book activity monitoring system is disclosed. The system comprises a phone 100 including an attribute to represent a parent user; an associated email address of the parent user; a front camera 120 device placed on front of the phone 100 that captures readers; a back camera 110 device placed on back of the phone 100 that captures reading environment; an electronic book 130 displayable on the phone 100, wherein the book includes a book name; and at least one session of the book is marked with a restricted rating proposed for the book's intended reader; is allowed to be read at a allowed time period; is marked as confidential sessions; is allowed to be read at a allowed time period; and is allowed to be read at a permitted location.

Further, a clock may be provided, which is used to detect whether the session of the book is being read outside the allowed time period; a location detection unit used to detect whether the session of the book is being read at the permitted location; a processing unit adapted to execute a set of instructions stored in a memory, comprising opening the book, after a request is made by a young reader to display the book on the phone 100; opening the session of the book, after a request is made by the reader to display the session of the book that is marked with the restricted rating proposed for the book's intended reader, wherein during the opening of the session, a snapshot is taken, the snapshot comprising using the camera at the front to capture an image of the reader, wherein the image includes an eye of the reader that can be used to analyze concentration of the reader when reading the session; using the camera at the back to capture an image of the reading environment; performing a print-screen function to capture what is being displayed on the phone 100; using the clock to record current time of the opening of the session; associating the session of the book with the snapshot; creating an index for the snapshot; and storing the index for the snapshot; browsing at the session of the book that includes words inappropriate for young adults, wherein during the browsing of the session, a second snapshot is taken, the snapshot comprising using the camera at the front to capture an second image of the reader, wherein the image includes an eye of the reader that can be used to analyze the concentration of the reader when reading the session; using the camera at the back to capture an second image of the reading environment; performing a print-screen function to capture what is being displayed on the phone 100; using the clock to record current time of the session; associating the session of the book with the snapshot; creating an index for the snapshot; and storing the index for the snapshot; browsing at the session of the book that is marked confidential, wherein during the browsing of the session, a third snapshot is taken, the snapshot comprising using the camera at the front to capture an third image of the reader, wherein the image includes an eye of the reader that can be used to analyze the concentration of the reader when reading the session using the camera at the back to capture an third image of the reading environment; performing a print-screen function to capture what is being displayed on the phone 100; using the clock to record current time of the session; associating the session of the book with the snapshot; creating an index for the snapshot; and storing the index for the snapshot.

Browsing at the session of the book that is being read outside the allowed time period is permitted. Here, a fourth snapshot is taken. The snapshot comprises using the camera at the front to capture an fourth image of the reader, wherein the image includes an eye of the reader that can be used to analyze the concentration of the reader when reading the session; using the camera at the back to capture an fourth image of the reading environment; performing a print-screen function to capture what is being displayed on the phone 100; using the clock to record current time of the session; associating the session of the book with the snapshot; creating an index for the snapshot; and storing the index for the snapshot; browsing at the session of the book that is being read at the certain place, during which the browsing being detected by the location detection unit, a fifth snapshot is taken, the snapshot comprising using the camera at the front to capture an fifth image of the reader, wherein the image includes an eye of the reader that can be used to analyze the concentration of the reader when reading the session; using the camera at the back to capture an fifth image of the reading environment; performing a print-screen function to capture what is being displayed on the phone 100; using the clock to record current time of the session; associating the session of the book with the snapshot; creating an index for the snapshot; and storing the index for the snapshot; after the creation of the snapshots, creating a monitoring alert to notify the parent user, wherein the alert includes the snapshots; allowing the parent user to browse the snapshots through the index; upon request of the parent user, creating an annotated version of the electronic book 130; creating a bookmark for the annotated version of the electronic book 130; adding the snapshots into the bookmark; including the snapshots into the annotated version of the electronic book 130 as annotations; and including the index for the snapshots into the annotated version of the electronic book 130 that facilities searching of reading history of the electronic book 130.

Inventions can be implemented as methods, which are computer-implemented executable on computer processors. As an example, a method includes opening a book, after a request is made by a reader to display the book on a phone 100; opening a session of the book, after a request is made by the reader to display the session of the book that is marked with a restricted rating proposed for the book's intended reader, wherein during the opening of the session, a snapshot is taken, the snapshot comprising using a camera at the front to capture an image of the reader; using the camera at the back to capture an image of the reading environment; performing a print-screen function to capture what is being displayed on the phone 100; using a clock to record current time of the opening of the session; associating the session of the book with the snapshot; creating an index for the snapshot; and storing the index for the snapshot; after the creation of the snapshot, creating a monitoring alert to notify the user, wherein the alert includes the snapshot; allowing the user to browse the snapshot through the index; upon request of the user, creating an annotated version of the electronic book 130; creating a bookmark for the annotated version of the electronic book 130; adding the snapshot into the bookmark; including the snapshot into the annotated version of the electronic book 130 as annotations; and including the index for the snapshots into the annotated version of the electronic book 130 that facilities searching of reading history of the electronic book 130.

An alternative embodiment of an exemplary method includes browsing at a session of the book that includes words inappropriate for young adults, wherein during the browsing of the session, a second snapshot is taken, the snapshot comprising using the camera at the front to capture an second image of the reader; using the camera at the back to capture an second image of the reading environment; performing a print-screen function to capture what is being displayed on the phone 100; using the clock to record current time of the session; associating the session of the book with the snapshot; creating an index for the snapshot; and storing the index for the snapshot.

Method steps according to embodiments of the invention can be performed by a programmable processor executing a program of instructions to perform functions or steps of the methods by operating based on input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, or in assembly or machine code. The language or code can be a compiled or interpreted language or code. Processors may include general and special purpose microprocessors. A processor receives instructions and data from memories, in particular from read-only memories or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in application-specific integrated circuits (ASICs).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Although illustrative embodiments have been described herein with reference to the accompanying drawings, it is noted that the invention is not limited to the precise system and method embodiments described herein, and that various other changes and modifications may be affected by one skilled in the art without departing from the scope or spirit of the invention. All such changes and modifications are intended to be included within the scope of the invention as defined by the appended claims.

What is claimed is:

1. An book activity monitoring system comprising:
a phone including:
an attribute to represent a user;
an associated email address of the user;
a front camera device placed on front of the phone that captures readers;
a back camera device placed on back of the phone that captures reading environment;
an electronic book displayable on the phone, wherein:
the book includes a book name; and
at least one session of the book:
marked with a restricted rating proposed for the book's intended reader;
allowed to be read at a allowed time period;
marked as confidential sessions;
allowed to be read at a allowed time period; and
allowed to be read at a permitted location;
a clock used to detect whether the session of the book is being read outside the allowed time period;
a location detection unit used to detect whether the session of the book is being read at the permitted location; and
a processing unit adapted to execute a set of instructions stored in a memory, comprising:
opening the book, after a request is made by a reader to display the book on the phone;
opening the session of the book, after a request is made by the reader to display the session of the book that is marked with the restricted rating proposed for the book's intended reader, wherein during the opening of the session, a snapshot is taken, the snapshot comprising:
using the camera at the front to capture an image of the reader;
using the camera at the back to capture an image of the reading environment;
performing a print-screen function to capture what is being displayed on the phone;
using the clock to record current time of the opening of the session;
associating the session of the book with the snapshot;
creating an index for the snapshot; and
storing the index for the snapshot;
after the creation of the snapshot, creating a monitoring alert to notify the user, wherein the alert includes the snapshot;
allowing the user to browse the snapshot through the index;
upon request of the user, creating an annotated version of the electronic book;
creating a bookmark for the annotated version of the electronic book;
adding the snapshot into the bookmark;
including the snapshot into the annotated version of the electronic book as annotations; and
including the index for the snapshots into the annotated version of the electronic book that facilities searching of reading history of the electronic book.

2. The system of claim 1, wherein the user is a parent user;

3. The system of claim 2, wherein the set of instructions comprises, after the snapshot is taken:
browsing at the session of the book that includes words inappropriate for young adults, wherein during the browsing of the session, a second snapshot is taken, the snapshot comprising:
using the camera at the front to capture an second image of the reader;
using the camera at the back to capture an second image of the reading environment;
performing a print-screen function to capture what is being displayed on the phone;
using the clock to record current time of the session;
associating the session of the book with the snapshot;
creating an index for the snapshot; and
storing the index for the snapshot; and
creating a second monitoring alert to notify the parent user after the creation of the second snapshot, wherein the alert includes the second snapshot.

4. The system of claim 3, wherein the set of instructions further comprises:
browsing at the session of the book that is marked confidential, wherein during the browsing of the session, a third snapshot is taken, the snapshot comprising:
using the camera at the front to capture an third image of the reader;
using the camera at the back to capture an third image of the reading environment;
performing a print-screen function to capture what is being displayed on the phone;
using the clock to record current time of the session;
associating the session of the book with the snapshot;
creating an index for the snapshot; and
storing the index for the snapshot.

5. The system of claim 4, wherein the set of instructions further comprises:
browsing at the session of the book that is marked confidential, wherein during the browsing of the session, a third snapshot is taken, the snapshot comprising:
using the camera at the front to capture an third image of the reader;
using the camera at the back to capture an third image of the reading environment;
performing a print-screen function to capture what is being displayed on the phone;
using the clock to record current time of the session;
associating the session of the book with the snapshot;
creating an index for the snapshot; and
storing the index for the snapshot; and
browsing at the session of the book that is being read outside the allowed time period, a fourth snapshot is taken, the snapshot comprising:
using the camera at the front to capture an fourth image of the reader;
using the camera at the back to capture an fourth image of the reading environment;
performing a print-screen function to capture what is being displayed on the phone;
using the clock to record current time of the session;
associating the session of the book with the snapshot;
creating an index for the snapshot; and
storing the index for the snapshot.

6. The system of claim 5, wherein the set of instructions further comprises, after the fourth snapshot is taken, the fourth image includes an eye of the reader that can be used to analyze the concentration of the reader when reading the session.

7. A computer-implemented method comprises:
opening a book, after a request is made by a reader to display the book on a phone;
opening a session of the book, after a request is made by the reader to display the session of the book that is marked with a restricted rating proposed for the book's intended reader, wherein during the opening of the session, a snapshot is taken, the snapshot comprising:
using a camera at the front to capture an image of the reader;
using the camera at the back to capture an image of the reading environment;
performing a print-screen function to capture what is being displayed on the phone;
using a clock to record current time of the opening of the session;
associating the session of the book with the snapshot;
creating an index for the snapshot; and
storing the index for the snapshot;
after the creation of the snapshot, creating a monitoring alert to notify the user, wherein the alert includes the snapshot;
allowing the user to browse the snapshot through the index;
upon request of the user, creating an annotated version of the electronic book;
creating a bookmark for the annotated version of the electronic book;
adding the snapshot into the bookmark;
including the snapshot into the annotated version of the electronic book as annotations; and
including the index for the snapshots into the annotated version of the electronic book that facilities searching of reading history of the electronic book.

8. The method of claim 7, further comprises
browsing at a session of the book that includes words inappropriate for young adults, wherein during the browsing of the session, a second snapshot is taken, the snapshot comprising:
using the camera at the front to capture an second image of the reader;
using the camera at the back to capture an second image of the reading environment;
performing a print-screen function to capture what is being displayed on the phone;
using the clock to record current time of the session;
associating the session of the book with the snapshot;
creating an index for the snapshot; and
storing the index for the snapshot.
